(19) United States
(12) Patent Application Publication
(10) Pub. No.: US 2026/0261834 A1
(43) Pub. Date: Sep. 3, 2026

(54) INFORMATION PROCESSING APPARATUS, COMMUNICATION CONTROL APPARATUS, INFORMATION PROCESSING METHOD, AND STORAGE MEDIUM

(71) Applicant: NEC Corporation, Minato-ku, Tokyo (JP)

(72) Inventor: Shinji KIRIBAYASHI, Tokyo (JP)

(73) Assignee: NEC Corporation, Minato-ku, Tokyo (JP)

(21) Appl. No.: 18/846,695

(22) PCT Filed: Mar. 23, 2022
(86) PCT No.: PCT/JP2022/013576

§ 371 Date: Sep. 13, 2024

(51) Int. Cl. H04W 4/90; G08B 27/00; H04W 4/021

(52) U.S. Cl. CPC H04W 4/90; G08B 27/006; H04W 4/021

(57) ABSTRACT

In order to provide a technique to distribute or receive appropriate distribution information in a system for distributing information at one time, an information processing apparatus (1) includes: an acquisition section (11) for acquiring an identifier of a first area; a selection section (12) for selecting, as distribution information for each of a plurality of second areas, distribution information which is associated with the first area indicated by the identifier acquired by the acquisition section (11) and which is associated with the second area; and a transmission section (13) for transmitting, for each of the plurality of second areas, data including an identifier of the second area and an identifier of distribution information which has been selected for the second area.

### TECHNICAL FIELD

The present invention relates to an information processing apparatus, a communication control apparatus, a transmission apparatus, a terminal apparatus, an information distribution system, an information processing method, a communication control method, a transmission method, and a program.

### BACKGROUND ART

A technique is disclosed which is related to a system that is used in a case where an emergency occurs or the like and that distributes a message at one time to terminal apparatuses which are present in a target area.

Patent Literature 1 discloses a system for distributing emergency information to a user apparatus using an earthquake ant tsunami warning system (ETWS). The system disclosed in Patent Literature 1 has a configuration in which a user apparatus detects whether or not first emergency information distributed from a network overlaps with second emergency information distributed after the first emergency information.

### CITATION LIST

### Patent Literature

### Patent Literature 1

International Publication No. WO 2020/100541

### SUMMARY OF INVENTION

### Technical Problem

The emergency information distributed in the system disclosed in Patent Literature 1 is not emergency information prepared while taking into consideration an area in which an emergency has occurred and an area in which a message is distributed. Therefore, there is a problem that, for example, in a case where the emergency information includes information indicating an evacuation route, it is impossible appropriate evacuation route to a user apparatus.

An example aspect of the present invention is accomplished in view of the above problem, and an example object thereof is to provide a technique for distributing or receiving appropriate distribution information in a system for distributing information at one time.

### Solution to Problem

An information processing apparatus in accordance with an example aspect of the present invention includes: an acquisition means for acquiring an identifier of a first area; a selection means for selecting, as distribution information for each of a plurality of second areas, distribution information which is associated with the first area indicated by the identifier acquired by the acquisition means and which is associated with the second area; and a transmission means for transmitting, for each of the plurality of second areas, data including an identifier of the second area and an identifier of distribution information which has been selected for the second area.

A communication control apparatus in accordance with an example aspect of the present invention includes: an acquisition means for acquiring data including a plurality of sets each of which is constituted by (i) an identifier of distribution information that is associated with a first area and a second area and that is for the second area and (ii) a second area identifier that indicates each of a plurality of second areas; and a transmission means for transmitting, to a transmission apparatus which corresponds to each area indicated by the second area identifier, the identifier of the distribution information for the second area.

A transmission apparatus in accordance with an example aspect of the present invention includes: an acquisition means for acquiring an identifier of distribution information which is associated with a first area and a second area and which is for the second area covered by the transmission apparatus; and a transmission means for transmitting the identifier of the distribution information to one or more terminal apparatuses which are present in the second area.

A terminal apparatus in accordance with an example aspect of the present invention includes: an acquisition means for acquiring an identifier of distribution information that is associated with a first area and a second area in which the terminal apparatus is present and that is for the second area; and an action control means for carrying out predetermined action control in response to acquisition of the identifier of the distribution information.

An information distribution system in accordance with an example aspect of the present invention includes an information processing apparatus, a communication control apparatus, a transmission apparatus, and a terminal apparatus, the information processing apparatus including a first acquisition means for acquiring an identifier of a first area, a first selection means for selecting, as distribution information for each of a plurality of second areas, distribution information which is associated with the first area indicated by the identifier acquired by the first acquisition means and which is associated with the second area, and a first transmission means for transmitting, for each of the plurality of second areas, data to the communication control apparatus, the data including an identifier of the second area and an identifier of distribution information which has been selected for the second area, the communication control apparatus including a second acquisition means for acquiring data which has been transmitted from the information processing apparatus, the data including the identifier of the second area and the identifier of the distribution information which has been selected for the second area, and a second transmission means for transmitting, to a transmission apparatus which corresponds to each area indicated by the identifier of the second area, the identifier of the distribution information for the second area, the transmission apparatus including a third acquisition means for acquiring the identifier of the distribution information for the second area which is covered by the transmission apparatus, the identifier of the distribution information having been transmitted by the communication control apparatus, and a third transmission means for transmitting the identifier of the distribution information to one or more terminal apparatuses which are present in the second area, and the terminal apparatus including a fourth acquisition means for acquiring the identifier of the distribution information for the second area in which the terminal apparatus is present, the identifier of the distribution information having been transmitted by the transmission apparatus, and an action control means for carrying out predetermined action control in response to acquisition of the identifier of the distribution information.

An information processing method in accordance with an example aspect of the present invention includes: acquiring, by an information processing apparatus, an identifier of a first area; selecting, as distribution information for each of a plurality of second areas, by the information processing apparatus, distribution information which is associated with the first area indicated by the identifier acquired in the acquiring and which is associated with the second area; and transmitting, for each of the plurality of second areas, by the information processing apparatus, data including an identifier of the second area and an identifier of distribution information which has been selected for the second area.

A communication control method in accordance with an example aspect of the present invention includes: acquiring, by a communication control apparatus, data including a plurality of sets each of which is constituted by (i) an identifier of distribution information that is associated with a first area and a second area and that is for the second area and (ii) a second area identifier that indicates each of a plurality of second areas; and transmitting, by the communication control apparatus, the identifier of the distribution information for the second area to a transmission apparatus which corresponds to each area indicated by the second area identifier.

A transmission apparatus in accordance with an example aspect of the present invention includes: acquiring, by the transmission apparatus, an identifier of distribution information which is associated with a first area and a second area and which is for the second area covered by the transmission apparatus; and transmitting, by the transmission apparatus, the identifier of the distribution information to one or more terminal apparatuses which are present in the second area.

An information processing method in accordance with an example aspect of the present invention includes: acquiring, by a terminal apparatus, an identifier of distribution information that is associated with a first area and a second area in which the terminal apparatus is present and that is for the second area; and carrying out, by the terminal apparatus, predetermined action control in response to acquisition of the identifier of the distribution information.

A program in accordance with an example aspect of the present invention causes a computer to function as an information processing apparatus, the program causing the computer to function as: an acquisition means for acquiring an identifier of a first area; a selection means for selecting, as distribution information for each of a plurality of second areas, distribution information which is associated with the first area indicated by the identifier acquired by the acquisition means and which is associated with the second area; and a transmission means for transmitting, for each of the plurality of second areas, data including an identifier of the second area and an identifier of distribution information which has been selected for the second area.

A program in accordance with an example aspect of the present invention causes a computer to function as a communication control apparatus, the program causing the computer to function as: an acquisition means for acquiring data including a plurality of sets each of which is constituted by (i) an identifier of distribution information that is associated with a first area and a second area and that is for the second area and (ii) a second area identifier that indicates each of a plurality of second areas; and a transmission means for transmitting, to a transmission apparatus which corresponds to each area indicated by the second area identifier, the identifier of the distribution information for the second area.

A program in accordance with an example aspect of the present invention causes a computer to function as a transmission apparatus, the program causing the computer to function as: an acquisition means for acquiring an identifier of distribution information which is associated with a first area and a second area and which is for the second area covered by the transmission apparatus; and a transmission means for transmitting the identifier of the distribution information to one or more terminal apparatuses which are present in the second area.

A program in accordance with an example aspect of the present invention causes a computer to function as a terminal apparatus, the program causing the computer to function as: an acquisition means for acquiring an identifier of distribution information that is associated with a first area and a second area in which the terminal apparatus is present and that is for the second area; and an action control means for carrying out predetermined action control in response to acquisition of the identifier of the distribution information.

### Advantageous Effects of Invention

According to an example aspect of the present invention, appropriate distribution information can be distributed or received in a system for distributing information at one time.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method in accordance with the first example embodiment of the present invention.

FIG. 3 is a block diagram illustrating a configuration of a communication control apparatus in accordance with the first example embodiment of the present invention.

FIG. 4 is a flowchart illustrating a flow of a communication control method in accordance with the first example embodiment of the present invention.

FIG. 5 is a block diagram illustrating a configuration of a transmission apparatus in accordance with the first example embodiment of the present invention.

FIG. 6 is a flowchart illustrating a flow of a transmission method in accordance with the first example embodiment of the present invention.

FIG. 7 is a block diagram illustrating a configuration of a terminal apparatus in accordance with the first example embodiment of the present invention.

FIG. 8 is a flowchart illustrating a flow of an information processing method in accordance with the first example embodiment of the present invention.

FIG. 9 is a block diagram illustrating a configuration of an information distribution system in accordance with the first example embodiment of the present invention.

FIG. 10 is a schematic diagram illustrating an overview of an information distribution system in accordance with a second example embodiment of the present invention.

FIG. 11 is a block diagram illustrating a configuration of an information distribution system in accordance with the second example embodiment of the present invention.

FIG. 12 is a diagram illustrating an example of a process which is carried out by a control section of an information processing apparatus in accordance with the second example embodiment of the present invention.

FIG. 13 is a diagram illustrating an example of a process which is carried out by a control section of a communication control apparatus and a control section of a transmission apparatus in accordance with the second example embodiment of the present invention.

FIG. 14 is a diagram illustrating an example of a process which is carried out by a control section of a terminal apparatus in accordance with the second example embodiment of the present invention.

FIG. 15 is a diagram illustrating an example of an image which is presented to a user by a presentation section in accordance with the second example embodiment of the present invention.

FIG. 16 is a diagram illustrating another example of a process which is carried out by the control section of the terminal apparatus in accordance with the second example embodiment of the present invention.

FIG. 17 is a block diagram illustrating an example of a hardware configuration of the information processing apparatus, communication control apparatus, transmission apparatus, and terminal apparatus in accordance with each of the example embodiments of the present invention.

### EXAMPLE EMBODIMENTS

### First Example Embodiment

The following description will discuss a first example embodiment of the present invention in detail, with reference to the drawings. The present example embodiment is a basic form of example embodiments described later.

### Overview of Information Processing Apparatus 1

The information processing apparatus 1 in accordance with the present example embodiment is an apparatus used in an information distribution system for distributing, at one time, distribution information to terminal apparatuses which are present in each of a plurality of predetermined areas, upon occurrence of an event related to a certain area. In the present example embodiment, the certain area is referred to as a first area, and each of the plurality of predetermined areas is referred to as a second area.

An example of the information processing apparatus 1 is an operation terminal used by a building manager. Examples of the event include emergencies such as accidents and disasters.

The first area is an area related to an event due to which the information processing apparatus 1 transmits data including an identifier of distribution information and an identifier of a second area. For example, the first area is an area related to occurrence of an emergency.

The second area is an area in which distribution information selected by the information processing apparatus 1 is distributed. There are a plurality of second areas. For example, the second area is an area to be notified of occurrence of an emergency.

Here, a relation between the first area and the second area is not particularly limited. In other words, the first area may be an area that is included in the plurality of second areas, or may be an area that is not included in the plurality of second areas.

The distribution information is information which is distributed to each of the second areas and which is associated with the first area and the second area. For example, the distribution information includes route information associated with the first area and the second area. As another example, the distribution information includes evacuation route information associated with the first area and the second area.

In the information distribution system, terminal apparatuses to which distribution information is distributed at one time may be all terminal apparatuses which are present in each of a plurality of predetermined areas, or may be a predetermined terminal apparatus among terminal apparatuses which are present in each of a plurality of predetermined areas. The terminal apparatus only needs to be an apparatus that is capable of receiving distribution information. Examples of the terminal apparatus include an apparatus installed in an area and a mobile terminal. Details of the terminal apparatus will be described later.

The information processing apparatus 1 in accordance with the present example embodiment is an apparatus that acquires an identifier of a first area, selects distribution information which is for each of second areas and is associated with the first area and the second area, and transmits data including an identifier of the distribution information and an identifier of the second area.

### Configuration of Information Processing Apparatus 1

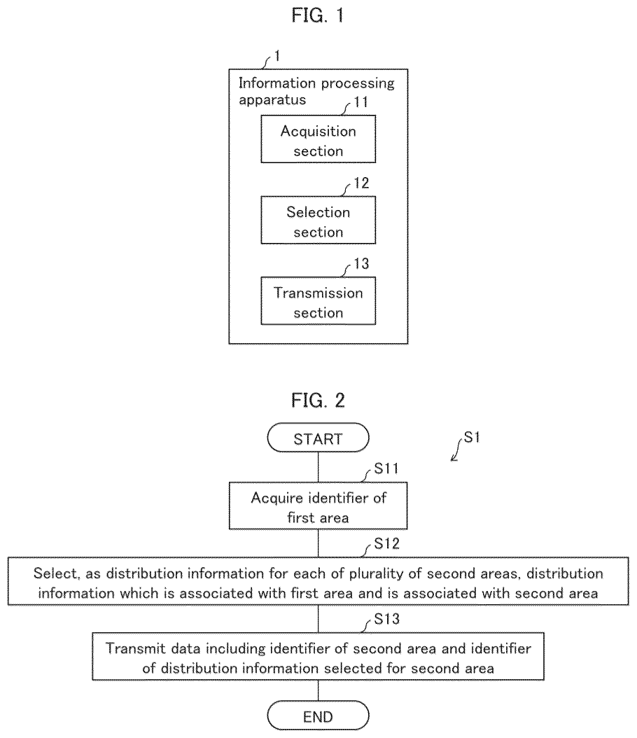

The following description will discuss a configuration of an information processing apparatus 1, with reference to FIG. 1. FIG. 1 is a block diagram illustrating the configuration of the information processing apparatus 1 in accordance with the present example embodiment.

As illustrated in FIG. 1, the information processing apparatus 1 includes an acquisition section 11, a selection section 12, and a transmission section 13. The acquisition section 11, the selection section 12, and the transmission section 13 are configured to realize the acquisition means, the selection means, and the transmission means in the present example embodiment, respectively.

The acquisition section 11 acquires an identifier of a first area. The acquisition section 11 supplies the acquired identifier of the first area to the selection section 12.

The selection section 12 selects, as distribution information for each of a plurality of second areas, distribution information which is associated with the first area indicated by the identifier acquired by the acquisition section 11 and which is associated with the second area. The selection section 12 supplies, to the transmission section 13, the selected distribution information or an identifier of the distribution information.

The transmission section 13 transmits, for each of a plurality of second areas, data including an identifier of the second area and an identifier of distribution information which has been selected for the second area.

As described above, the information processing apparatus 1 in accordance with the present example embodiment employs the configuration of including: the acquisition section 11 for acquiring an identifier of a first area; the selection section 12 for selecting, as distribution information for each of a plurality of second areas, distribution information which is associated with the first area indicated by the identifier acquired by the acquisition section 11 and which is associated with the second area; and the transmission section 13 for transmitting, for each of the plurality of second areas, data including an identifier of the second area and an identifier of distribution information which has been selected for the second area.

As such, according to the information processing apparatus 1 in accordance with the present example embodiment, distribution information associated with two areas (i.e., the first area and the second area) is transmitted. Therefore, it is possible to bring about an example advantage of transmitting appropriate distribution information as compared with information which is associated with only one of areas.

### Flow of Information Processing Method S1

The following description will discuss a flow of an information processing method S1 in accordance with the present example embodiment, with reference to FIG. 2. FIG. 2 is a flowchart illustrating the flow of the information processing method S1 in accordance with the present example embodiment.

### Step S11

In step S11, the acquisition section 11 acquires an identifier of a first area. The acquisition section 11 supplies the acquired identifier of the first area to the selection section 12.

### Step S12

In step S12, the selection section 12 selects, as distribution information for each of a plurality of second areas, distribution information which is associated with the first area indicated by the identifier acquired by the acquisition section 11 in step S11 and which is associated with the second area. The selection section 12 supplies, to the transmission section 13, the selected distribution information or an identifier of the distribution information.

### Step S13

In step S13, the transmission section 13 transmits, for each of a plurality of second areas, data including an identifier of the second area and an identifier of distribution information which has been selected for the second area.

As described above, the information processing method S1 in accordance with the present example embodiment employs the configuration in which: in step S11, the acquisition section 11 acquires an identifier of a first area; in step S12, the selection section 12 selects, as distribution information for each of a plurality of second areas, distribution information which is associated with the first area indicated by the identifier acquired by the acquisition section 11 in step S11 and which is associated with the second area; and in step S13, the transmission section 13 transmits, for each of the plurality of second areas, data including an identifier of the second area and an identifier of distribution information which has been selected for the second area. Therefore, according to the information processing method S1 in accordance with the present example embodiment, an example advantage similar to that of the foregoing information processing apparatus 1 is brought about.

### Overview of Communication Control Apparatus 2

The communication control apparatus 2 in accordance with the present example embodiment is an apparatus used in an information distribution system for distributing, at one time, distribution information to terminal apparatuses which are present in each of a plurality of second areas, upon occurrence of an event related to a first area. Examples of the communication control apparatus 2 include an apparatus for controlling a radio access network (RAN) in a building.

The communication control apparatus 2 in accordance with the present example embodiment is an apparatus that acquires data including a plurality of sets each of which is constituted by (i) an identifier of distribution information that is associated with a first area and a second area and (ii) an identifier of the second area, and transmits, to a transmission apparatus which corresponds to each area indicated by the second area identifier, the identifier of the distribution information for the second area.

The transmission apparatus is an apparatus that transmits data to a terminal apparatus which is present in an area covered by the transmission apparatus. Details of the transmission apparatus will be described later. The information distribution system, the terminal apparatus, the first area, the second area, and the distribution information are as described above.

### Configuration of Communication Control Apparatus 2

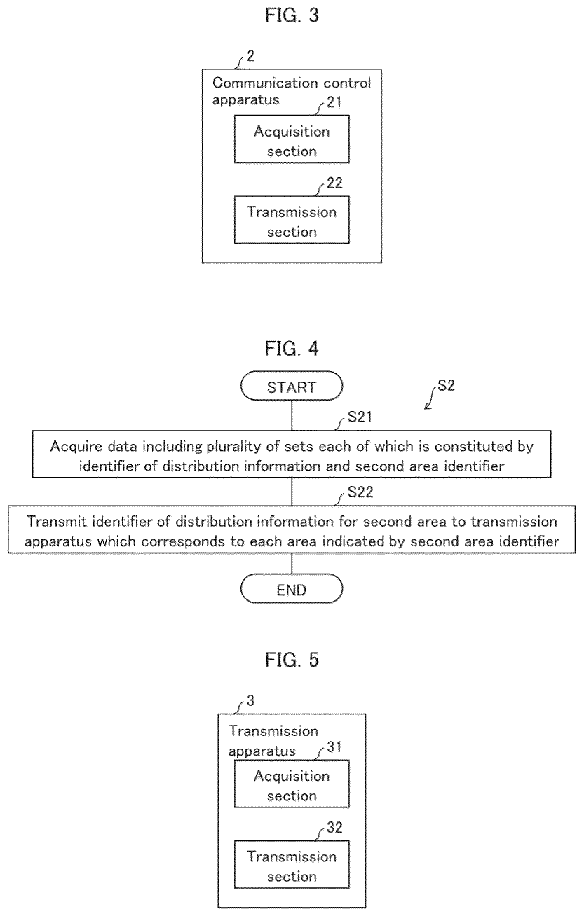

The following description will discuss a configuration of the communication control apparatus 2, with reference to FIG. 3. FIG. 3 is a block diagram illustrating the configuration of the communication control apparatus 2 in accordance with the present example embodiment.

As illustrated in FIG. 3, the communication control apparatus 2 includes an acquisition section 21 and a transmission section 22. The acquisition section 21 and the transmission section 22 are configured to realize the acquisition means and the transmission means in the present example embodiment, respectively.

The acquisition section 21 acquires data including a plurality of sets each of which is constituted by (i) an identifier of distribution information that is associated with a first area and a second area and that is for the second area and (ii) a second area identifier that indicates each of a plurality of second areas. The acquisition section 21 supplies the acquired data to the transmission section 22.

The transmission section 22 transmits the identifier of the distribution information for the second area to a transmission apparatus which corresponds to each area indicated by the second area identifier.

As described above, the communication control apparatus 2 in accordance with the present example embodiment employs the configuration of including: the acquisition section 21 for acquiring data including a plurality of sets each of which is constituted by (i) an identifier of distribution information that is associated with a first area and a second area and that is for the second area and (ii) a second area identifier that indicates each of a plurality of second areas; and the transmission section 22 for transmitting, to a transmission apparatus which corresponds to each area indicated by the second area identifier, the identifier of the distribution information for the second area.

As such, according to the communication control apparatus 2 in accordance with the present example embodiment, the identifier of the distribution information associated with two areas (i.e., the first area and the second area) is transmitted to a transmission apparatus which corresponds to each area indicated by the second area identifier. Therefore, it is possible to bring about an example advantage of transmitting, to the transmission apparatus corresponding to the second area, appropriate distribution information as compared with information associated with only one of areas.

### Flow of Communication Control Method S2

The following description will discuss a flow of a communication control method S2 in accordance with the present example embodiment, with reference to FIG. 4. FIG. 4 is a flowchart illustrating the flow of the communication control method S2 in accordance with the present example embodiment.

### Step S21

In step S21, the acquisition section 21 acquires data including a plurality of sets each of which is constituted by (i) an identifier of distribution information that is associated with a first area and a second area and that is for the second area and (ii) a second area identifier that indicates each of a plurality of second areas. The acquisition section 21 supplies the acquired data to the transmission section 22.

### Step S22

In step S22, the transmission section 22 transmits the identifier of the distribution information for the second area to a transmission apparatus which corresponds to each area indicated by the second area identifier.

As described above, in the communication control method S2 in accordance with the present example embodiment: in step S21, the acquisition section 21 acquires data including a plurality of sets each of which is constituted by (i) an identifier of distribution information that is associated with a first area and a second area and that is for the second area and (ii) a second area identifier that indicates each of a plurality of second areas; and in step S22, the transmission section 22 transmits, to a transmission apparatus which corresponds to each area indicated by the second area identifier, the identifier of the distribution information for the second area. Therefore, according to the communication control method S2 in accordance with the present example embodiment, it is possible to bring about an example advantage similar to that of the foregoing communication control apparatus 2.

### Overview of Transmission Apparatus 3

The transmission apparatus 3 in accordance with the present example embodiment is an apparatus used in an information distribution system for distributing, at one time, distribution information to terminal apparatuses which are present in each of a plurality of second areas, upon occurrence of an event related to a first area. Examples of the transmission apparatus 3 include a radio unit (RU) that constitutes a RAN in a building.

The transmission apparatus 3 in accordance with the present example embodiment is an apparatus that acquires an identifier of distribution information associated with a first area and a second area and transmits the identifier of the distribution information to one or more terminal apparatuses which are present in the second area covered by the transmission apparatus 3.

The terminal apparatus is an apparatus capable of receiving data from the transmission apparatus 3. Details of the terminal apparatus will be described later. The information distribution system, the terminal apparatus, the first area, the second area, and the distribution information are as described above.

### Configuration of Transmission Apparatus 3

The following description will discuss a configuration of the transmission apparatus 3, with reference to FIG. 5. FIG. 5 is a block diagram illustrating the configuration of the transmission apparatus 3 in accordance with the present example embodiment.

As illustrated in FIG. 5, the transmission apparatus 3 includes an acquisition section 31 and a transmission section 32. The acquisition section 31 and the transmission section 32 are configured to realize the acquisition means and the transmission means in the present example embodiment, respectively.

The acquisition section 31 acquires an identifier of distribution information which is associated with a first area and a second area and which is for the second area covered by the transmission apparatus 3. The acquisition section 31 supplies the acquired identifier of the distribution information to the transmission section 32.

The transmission section 32 transmits the identifier of the distribution information to one or more terminal apparatuses which are present in the second area.

As described above, the transmission apparatus 3 in accordance with the present example embodiment employs the configuration of including: the acquisition section 31 for acquiring an identifier of distribution information which is associated with a first area and a second area and which is for the second area covered by the transmission apparatus; and the transmission section 32 for transmitting the identifier of the distribution information to one or more terminal apparatuses which are present in the second area.

As such, according to the transmission apparatus 3 in accordance with the present example embodiment, an identifier of distribution information associated with two areas (i.e., the first area and the second area) is transmitted to one or more terminal apparatuses which are present in the second area covered by the transmission apparatus 3. Therefore, it is possible to bring about an example advantage of distributing, to one or more terminal apparatuses which are present in the second area, appropriate distribution information as compared with information which is associated with only one of areas.

### Flow of Transmission Method S3

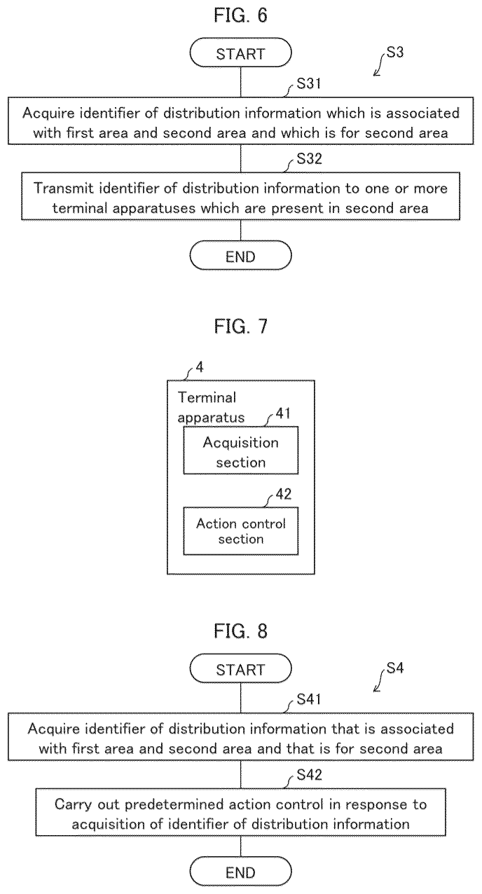

The following description will discuss a flow of a transmission method S3 in accordance with the present example embodiment, with reference to FIG. 6. FIG. 6 is a flowchart illustrating the flow of the transmission method S3 in accordance with the present example embodiment.

### Step S31

In step S31, the acquisition section 31 acquires an identifier of distribution information which is associated with a first area and a second area and which is for the second area covered by the transmission apparatus 3. The acquisition section 31 supplies the acquired identifier of the distribution information to the transmission section 32.

### Step S32

In step S32, the transmission section 32 transmits the identifier of the distribution information to one or more terminal apparatuses which are present in the second area.

As described above, in the transmission method S3 in accordance with the present example embodiment: in step S31, the acquisition section 31 acquires an identifier of distribution information which is associated with a first area and a second area and which is for the second area covered by the transmission apparatus 3; and in step S32, the transmission section 32 transmits the identifier of the distribution information to one or more terminal apparatuses which are present in the second area. Therefore, according to the transmission method S3 in accordance with the present example embodiment, it is possible to bring about an example advantage similar to 1 foregoing transmission apparatus 3.

### Overview of Terminal Apparatus 4

The terminal apparatus 4 in accordance with the present example embodiment is an apparatus used in an information distribution system in which distribution information is distributed at one time to apparatuses which are present in each of a plurality of second areas, upon occurrence of an event related to a first area. The terminal apparatus 4 is an apparatus which is present in each of a plurality of second areas and which receives distribution information. Examples of the terminal apparatus 4 include an apparatus which is installed in a building and a mobile terminal.

The terminal apparatus 4 in accordance with the present example embodiment is an apparatus which acquires an identifier of distribution information that is associated with a first area and a second area in which the terminal apparatus 4 is present and that is for the second area, and carries out predetermined action control in response to acquisition of the identifier of the distribution information.

Examples of the predetermined action control carried out by the terminal apparatus 4 include displaying a predetermined image and stopping action of the terminal apparatus 4 or another predetermined apparatus different from the terminal apparatus 4. The first area, the second area, and the distribution information are as described above.

### Configuration of Terminal Apparatus 4

The following description will discuss a configuration of the terminal apparatus 4, with reference to FIG. 7. FIG. 7 is a block diagram illustrating the configuration of the terminal apparatus 4 in accordance with the present example embodiment.

As illustrated in FIG. 7, the terminal apparatus 4 includes an acquisition section 41 and an action control section 42. The acquisition section 41 and the action control section 42 are configured to realize the acquisition means and the action control means in the present example embodiment, respectively.

The acquisition section 41 acquires an identifier of distribution information that is associated with a first area and a second area in which the terminal apparatus 4 is present and that is for the second area. The acquisition section 41 supplies the acquired distribution information to the action control section 42.

The action control section 42 carries out predetermined action control in response to acquisition of the identifier of the distribution information.

As described above, the terminal apparatus 4 in accordance with the present example embodiment employs the configuration of including: the acquisition section 41 for acquiring an identifier of distribution information that is associated with a first area and a second area in which the terminal apparatus 4 is present and that is for the second area; and the action control section 42 for carrying out predetermined action control in response to acquisition of the identifier of the distribution information.

As such, according to the terminal apparatus 4 in accordance with the present example embodiment, an identifier of distribution information associated with two areas (i.e., the first area and the second area) is acquired. Therefore, it is possible to bring about an example advantage of receiving appropriate distribution information as compared with information which is associated with only one of areas.

According to the terminal apparatus 4 in accordance with the present example embodiment, predetermined action control in response to acquisition of the identifier of the distribution information is carried out. Therefore, it is possible to carry out an appropriate process with respect to an event related to the first area.

### Flow of Information Processing Method S4

The following description will discuss a flow of an information processing method S4 in accordance with the present example embodiment, with reference to FIG. 8. FIG. 8 is a flowchart illustrating the flow of the information processing method S4 in accordance with the present example embodiment.

### Step S41

In step S41, the acquisition section 41 acquires an identifier of distribution information that is associated with a first area and a second area in which the terminal apparatus 4 is present and that is for the second area. The acquisition section 41 supplies the acquired distribution information to the action control section 42.

### Step S42

In step S42, the action control section 42 carries out predetermined action control in response to acquisition of the identifier of the distribution information.

As described above, in the information processing method S4 in accordance with the present example embodiment: in step S41, the acquisition section 41 acquires an identifier of distribution information that is associated with a first area and a second area in which the terminal apparatus 4 is present and that is for the second area; and in step S42, the action control section 42 carries out predetermined action control in response to acquisition of the identifier of the distribution information. Therefore, according to the information processing method S4 in accordance with the present example embodiment, an example advantage similar to that of the foregoing terminal apparatus 4 is brought about.

### Overview of Information Distribution System 100

The information distribution system 100 in accordance with the present example embodiment is a system for distributing distribution information to a plurality of second areas at one time, upon occurrence of an event related to a first area. Examples of the information distribution system 100 include a system that uses a RAN installed in a building.

The information distribution system 100 in accordance with the present example embodiment is a system which acquires an identifier of a first area and distributes, as distribution information for each of a plurality of second areas, distribution information which is associated with the first area and the second area to one or more terminal apparatuses which are present in each of the second areas. The first area, the second area, and the distribution information are as described above.

### Configuration of Information Distribution System 100

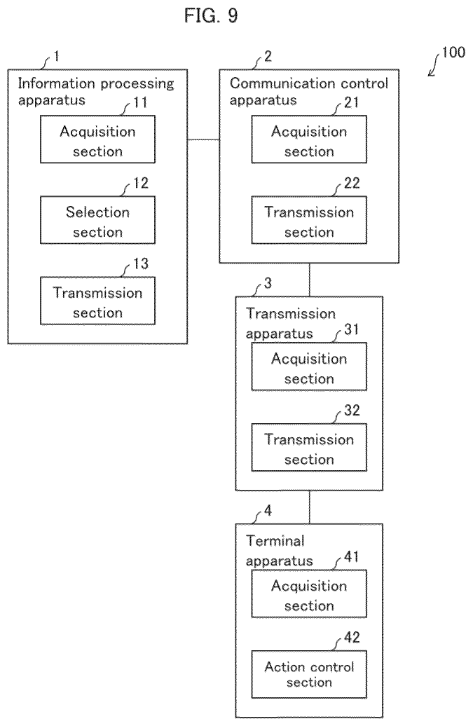

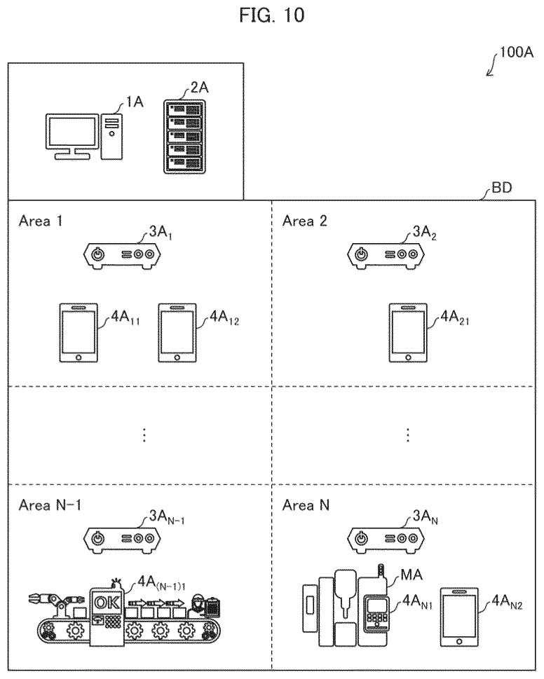

The following description will discuss a configuration of the information distribution system 100, with reference to FIG. 9. FIG. 9 is a block diagram illustrating the configuration of the information distribution system 100 in accordance with the present example embodiment.

As illustrated in FIG. 9, the information distribution system 100 is configured to include an information processing apparatus 1, a communication control apparatus 2, a transmission apparatus 3, and a terminal apparatus 4.

### Configuration of Information Processing Apparatus 1

As illustrated in FIG. 9, the information processing apparatus 1 includes an acquisition section 11, a selection section 12, and a transmission section 13. The acquisition section 11, the selection section 12, and the transmission section 13 are configured to realize the first acquisition means, the first selection means, and the first transmission means in the present example embodiment, respectively.

The acquisition section 11 acquires an identifier of a first area. The acquisition section 11 supplies the acquired identifier of the first area to the selection section 12.

The selection section 12 selects, as distribution information for each of a plurality of second areas, distribution information which is associated with the first area indicated by the identifier acquired by the acquisition section 11 and which is associated with the second area. The selection section 12 supplies, to the transmission section 13, the selected distribution information or an identifier of the distribution information.

The transmission section 13 transmits, for each of a plurality of second areas, data including an identifier of the second area and an identifier of distribution information which has been selected for the second area to the communication control apparatus 2.

### Configuration of Communication Control Apparatus 2

As illustrated in FIG. 9, the communication control apparatus 2 includes an acquisition section 21 and a transmission section 22. The acquisition section 21 and the transmission section 22 are configured to realize the second acquisition means and the second transmission means in the present example embodiment, respectively.

The acquisition section 21 acquires data including an identifier of a second area and an identifier of distribution information which has been selected for the second area, the data having been transmitted from the information processing apparatus 1. The acquisition section 21 supplies the acquired data to the transmission section 22.

The transmission section 22 transmits the identifier of the distribution information for the second area to the transmission apparatus 3 which corresponds to each area indicated by the second area identifier.

### Configuration of Transmission Apparatus 3

As illustrated in FIG. 9, the transmission apparatus 3 includes an acquisition section 31 and a transmission section 32. The acquisition section 31 and the transmission section 32 are configured to realize the third acquisition means and the third transmission means in the present example embodiment, respectively.

The acquisition section 31 acquires an identifier of distribution information for the second area covered by the transmission apparatus 3, the identifier having been transmitted from the communication control apparatus 2. The acquisition section 31 supplies the acquired data to the transmission section 32.

The transmission section 32 transmits the identifier of the distribution information to one or more terminal apparatuses 4 which are present in the second area.

### Configuration of Terminal Apparatus 4

As illustrated in FIG. 9, the terminal apparatus 4 includes an acquisition section 41 and an action control section 42. The acquisition section 41 and the action control section 42 are configured to realize the fourth acquisition means and the action control means in the present example embodiment, respectively.

The acquisition section 41 acquires an identifier of distribution information for the second area in which the terminal apparatus 4 is present, the identifier having been transmitted from the transmission apparatus 3.

The action control section 42 carries out predetermined action control in response to acquisition of the identifier of the distribution information. The predetermined action control is as described above.

As described above, the information distribution system 100 in accordance with the present example embodiment employs the configuration of including: the information processing apparatus 1 which acquires an identifier of a first area and transmits data including an identifier of a second area and an identifier of distribution information; the communication control apparatus 2 which acquires data including the identifier of the second area and the identifier of the distribution information and transmits the identifier of the distribution information for the second area to the transmission apparatus 3 corresponding to the second area; the transmission apparatus 3 that acquires the identifier of the distribution information and transmits the identifier of the distribution information to the terminal apparatus 4 that is present in the second area; and the terminal apparatus 4 which acquires the identifier of the distribution information and carries out predetermined action control in response to acquisition of the identifier.

As such, according to the information distribution system 100 in accordance with the present example embodiment, distribution information associated with two areas (i.e., the first area and the second area) is transmitted to the terminal apparatus 4. Therefore, it is possible to bring about an example advantage of distributing appropriate distribution information as compared with information which is associated with only one of areas.

According to the information distribution system 100 in accordance with the present example embodiment, the terminal apparatus 4 carries out predetermined action control in response to acquisition of the identifier of the distribution information. Therefore, it is possible to carry out appropriate action with respect to an event related to the first area.

According to the information distribution system 100 in accordance with the present example embodiment, data to be transmitted and received is an identifier. Therefore, a load of transmission and reception processing by apparatuses included in the information distribution system 100 can be reduced.

### Second Example Embodiment

The following description will discuss a second example embodiment of the present invention in detail, with reference to the drawings. The same reference numerals are given to constituent elements which have functions identical with those described in the first example embodiment, and descriptions as to such constituent elements are omitted as appropriate.

### Overview of Information Distribution System 100A

The following description will discuss an overview of an information distribution system 100A in accordance with the present example embodiment, with reference to FIG. 10. FIG. 10 is a schematic diagram illustrating an overview of the information distribution system 100A in accordance with the present example embodiment.

The information distribution system 100A in accordance with the present example embodiment is a system using a RAN constructed in a building BD. The RAN can be a RAN conforming to the fifth-generation mobile communication system (5G) standard. As illustrated in FIG. 10, the information distribution system 100A is configured to include an information processing apparatus 1A, a communication control apparatus 2A, a plurality of transmission apparatuses 3A, and a plurality of terminal apparatuses 4A.

In the information distribution system 100A, as illustrated in FIG. 10, the building BD is divided into N areas including areas 1 through N. In addition, in each of the areas in the information distribution system 100A, as illustrated in FIG. 10, a transmission apparatus 3A that covers each area and one or more terminal apparatuses 4A are present.

Here, a transmission apparatus 3A that covers an area X is referred to as a transmission apparatus 3A_{X}, and a plurality of terminal apparatuses 4A that are present in the area X are referred to as a terminal apparatus 4A_{X1}, a terminal apparatus 4A_{X2}, and so forth. For example, in the area N in FIG. 10, a transmission apparatus 3A_{N} that covers the area N, a terminal apparatus 4A_{N1}, and a terminal apparatus 4A_{N2} are present.

Here, installation locations of the information processing apparatus 1A and the communication control apparatus 2A are not particularly limited. The information processing apparatus 1A and the communication control apparatus 2A may be installed in any area in the building BD, or may be installed in a building different from the building BD.

The terminal apparatus 4A may be connected to another apparatus and control that another apparatus. For example, the terminal apparatus 4A_{N1} in FIG. 10 is connected with an apparatus MA which can be controlled by the terminal apparatus 4A_{N1}.

The information distribution system 100A is a system for distributing distribution information at one time to terminal apparatuses 4A which are present in a plurality of areas, upon occurrence of an event related to a certain area in the building BD. In the present example embodiment also, the certain area is referred to as a first area, and a plurality of areas are referred to as second areas. A relation between the first area and the second area is not particularly limited. In other words, the first area may be an area that is included in the plurality of second areas, or may be an area that is not included in the plurality of second areas.

The first area is, for example, an area related to occurrence of an emergency. Examples of the emergency include accidents and disasters. Another example of the emergency is an urgent operation (e.g., a cash register operation in a shopping mall in a case where many customers are waiting for payment).

The second area is, for example, an area to be notified of occurrence of an emergency. The plurality of second areas may correspond to a plurality of cells, respectively, which are provided by a local 5G network.

The distribution information includes, for example, route information associated with the first area and the second area. As another example, the distribution information includes evacuation route information associated with the first area and the second area. 100A)

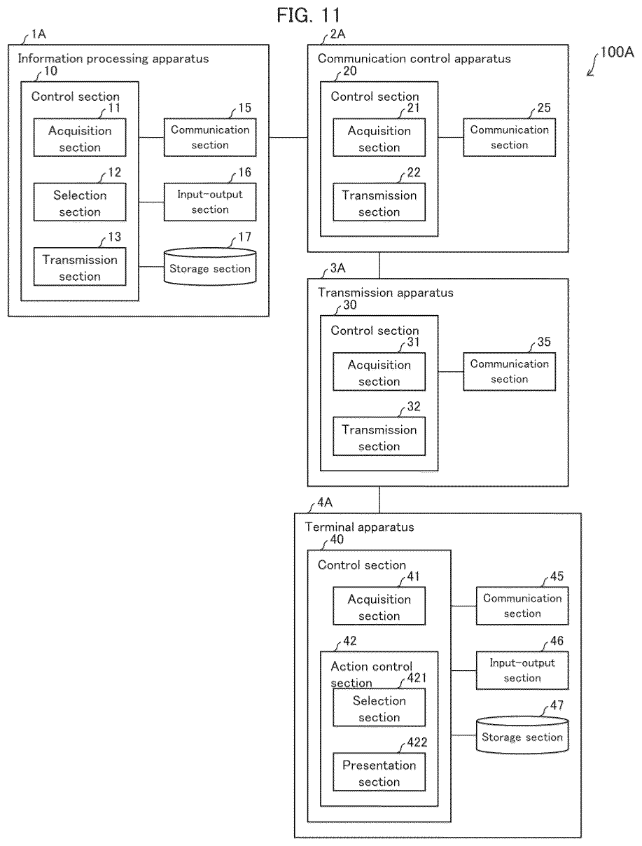

The following description will discuss a configuration of the information distribution system 100A, with reference to FIG. 11. FIG. 11 is a block diagram illustrating the configuration of the information distribution system 100A in accordance with the present example embodiment.

In the information distribution system 100A, as illustrated in FIG. 11, the information processing apparatus 1A and the communication control apparatus 2A are communicably connected to each other, the communication control apparatus 2A and the transmission apparatus 3A are communicably connected to each other, and the transmission apparatus 3A and the terminal apparatus 4A are communicably connected to each other.

### Configuration of Information Processing Apparatus 1A

As illustrated in FIG. 11, the information processing apparatus 1A includes a control section 10, a communication section 15, an input-output section 16, and a storage section 17.

The communication section 15 is a communication module that communicates with other apparatuses via a network (not illustrated). For example, the communication section 15 outputs, via a network, data supplied from the control section 10 to the communication control apparatus 2A.

The network to be used by the communication section 15 for transmission and reception of data can be the foregoing RAN, or can be a wireless local area network (LAN), a wired LAN, a wide area network (WAN), a public network, a mobile data communication network, or a combination of these networks.

The input-output section 16 is an interface for acquiring or outputting data. The input-output section 16 supplies the acquired data to the control section 10 or outputs data supplied from the control section 10. Examples of the input-output section 16 include a touch pad and a keyboard for acquiring data, and a display apparatus for outputting data.

In the storage section 17, data referred to by the control section 10 is stored. For example, the storage section 17 stores distribution information and an identifier of the distribution information.

### Function of Control Section 10

The control section 10 controls constituent elements included in the information processing apparatus 1A. As illustrated in FIG. 11, the control section 10 functions also as an acquisition section 11, a selection section 12, and a transmission section 13. The acquisition section 11 is configured to realize the acquisition means or the first acquisition means in the present example embodiment. The selection section 12 is configured to realize the selection means or the first selection means in the present example embodiment. The transmission section 13 is configured to realize the transmission means or the first transmission means in the present example embodiment.

The acquisition section 11 acquires data supplied from the input-output section 16. For example, the acquisition section 11 acquires an identifier of a first area. The acquisition section 11 supplies the acquired data to the selection section 12.

The selection section 12 selects a predetermined piece of data from pieces of data stored in the storage section 17. For example, the selection section 12 selects, from distribution information stored in the storage section 17, as distribution information for each of a plurality of second areas, distribution information which is associated with the first area indicated by the identifier supplied from the acquisition section 11 and which is associated with the second area. The selection section 12 acquires an identifier of the selected distribution information from the storage section 17 and supplies the identifier to the transmission section 13.

The transmission section 13 transmits data via the communication section 15. For example, the transmission section 13 transmits, for each of a plurality of second areas, data including an identifier of the second area and an identifier of distribution information which has been selected by the selection section 12 for the second area to the communication control apparatus 2A via the communication section 15.

An example of a process which is carried out by the control section 10 of the information processing apparatus 1A will be described later.

### Configuration of Communication Control Apparatus 2A

As illustrated in FIG. 11, the communication control apparatus 2A includes a control section 20 and a communication section 25.

The communication section 25 is a communication module that communicates with other apparatuses via a network (not illustrated). For example, the communication section 25 acquires data transmitted from the information processing apparatus 1A and supplies the data to the control section 20, and transmits data supplied from the control section 20 to the transmission apparatus 3A.

A network used by the communication section 25 for communication with the information processing apparatus 1A is as described above. A network used by the communication section 25 for communication with the transmission apparatus 3A is, for example, a RAN constructed in the foregoing building BD.

### Function of Control Section 20

The control section 20 controls constituent elements included in the communication control apparatus 2A. The control section 20 functions also as an acquisition section 21 and a transmission section 22, as illustrated in FIG. 11. The acquisition section 21 is configured to realize the acquisition means or the second acquisition means in the present example embodiment. The transmission section 22 is configured to realize the transmission means or the second transmission means in the present example embodiment.

The acquisition section 21 acquires data supplied from the communication section 25. For example, the acquisition section 21 acquires data including a plurality of sets each of which is constituted by (i) an identifier of distribution information that is associated with a first area and a second area and that is for the second area and (ii) a second area identifier that indicates each of a plurality of second areas, the data having been transmitted from the information processing apparatus 1A. The acquisition section 21 supplies the acquired data to the transmission section 22.

The transmission section 22 transmits data via the communication section 25. For example, the transmission section 22 transmits, via the communication section 25, the identifier of the distribution information for the second area to a transmission apparatus 3A which corresponds to each area indicated by the second area identifier.

An example of a process which is carried out by the control section 20 of the communication control apparatus 2A will be described later.

Configuration of transmission apparatus 3A

As illustrated in FIG. 11, the transmission apparatus 3A includes a control section 30 and a communication section 35.

The communication section 35 is a communication module that communicates with other apparatuses via a network (not illustrated). For example, the communication section 35 acquires data transmitted from the communication control apparatus 2A and supplies the data to the control section 30, and transmits data supplied from the control section 30 to the terminal apparatus 4A.

A network which is used by the communication section 35 for communication with the communication control apparatus 2A and the terminal apparatus 4A is, for example, a RAN which is constructed in the foregoing building BD.

### Function of Control Section 30

The control section 30 controls constituent elements included in the transmission apparatus 3A. The control section 30 functions also as an acquisition section 31 and a transmission section 32, as illustrated in FIG. 11. The acquisition section 31 is configured to realize the acquisition means or the third acquisition means in the present example embodiment. The transmission section 32 is configured to realize the transmission means or the third transmission means in the present example embodiment.

The acquisition section 31 acquires data supplied from the communication section 35. For example, the acquisition section 31 acquires an identifier of distribution information which is associated with a first area and a second area and which is for the second area covered by the transmission apparatus 3A, the identifier having been transmitted from the communication control apparatus 2A. The acquisition section 31 supplies the acquired data to the transmission section 32.

The transmission section 32 transmits data via the communication section 35. For example, the transmission section 32 transmits, via the communication section 35, an identifier of distribution information as a paging signal to the terminal apparatus 4A that is present in the second area.

An example of a process which is carried out by the control section 30 of the transmission apparatus 3A will be described later.

### Configuration of Terminal Apparatus 4A

As illustrated in FIG. 11, the terminal apparatus 4A includes a control section 40, a communication section 45, an input-output section 46, and a storage section 47.

The communication section 45 is a communication module that communicates with other apparatuses via a network (not illustrated). For example, the communication section 45 acquires data transmitted from the transmission apparatus 3A and supplies the data to the control section 40.

A network used by the communication section 45 for communication with the transmission apparatus 3A is, for example, a RAN constructed in the foregoing building BD.

The input-output section 46 is an interface for acquiring or outputting data. The input-output section 46 supplies the acquired data to the control section 40 or outputs data supplied from the control section 40. Examples of the input-output section 46 include a touch pad and a keyboard for acquiring data, and a display apparatus for outputting data.

In the storage section 47, data referred to by the control section 10 is stored. For example, the storage section 47 stores presentation information which is presented to the user via the input-output section 46 and which corresponds to the identifier of the distribution information. As another example, stop procedure information is stored which is referred to when the identifier of the distribution information is acquired by the control section 40 and which indicates a procedure of stopping action of the terminal apparatus 4A or one or more apparatuses which are connected to the terminal apparatus 4A.

### Function of Control Section 40

The control section 40 controls constituent elements included in the terminal apparatus 4A. The control section 40 functions also as an acquisition section 41 and an action control section 42, as illustrated in FIG. 11. The acquisition section 41 is configured to realize the acquisition means or the fourth acquisition means in the present example embodiment. The action control section 42 is configured to realize the action control means in the present example embodiment.

The acquisition section 41 acquires data supplied from the communication section 45 and the input-output section 46. For example, the acquisition section 41 acquires an identifier of distribution information that is associated with a first area and a second area in which the terminal apparatus 4 is present and that is for the second area. As another example, the acquisition section 41 acquires information indicating an input from a user. The acquisition section 41 supplies the acquired data to the action control section 42.

The action control section 42 controls action of the terminal apparatus 4A or an apparatus which is connected to the terminal apparatus 4A. For example, the action control section 42 carries out predetermined action control in response to acquisition of the identifier of the distribution information. Examples of the predetermined action control carried out by the terminal apparatus 4A include displaying a predetermined image and stopping action of the terminal apparatus 4A or another predetermined apparatus different from the terminal apparatus 4A.

The action control section 42 functions also as a selection section 421 and a presentation section 422, as illustrated in FIG. 11. The selection section 421 and the presentation section 422 are configured to realize the selection means and the presentation means in the present example embodiment, respectively.

The selection section 421 selects a predetermined piece of data from pieces of data stored in the storage section 47. For example, the selection section 421 selects, from pieces of presentation information stored in the storage section 47, a piece of presentation information which is identified by the identifier of the distribution information. The selection section 421 acquires the selected presentation information from the storage section 47 and supplies the selected presentation information to the presentation section 422.

The presentation section 422 presents data via the input-output section 46. For example, the presentation section 422 presents, via the input-output section 46, the presentation information selected by the selection section 421.

An example of a process which is carried out by the control section 40 of the terminal apparatus 4A will be described later.

### Example of Process Carried Out by Control Section 10 of Information Processing Apparatus 1A

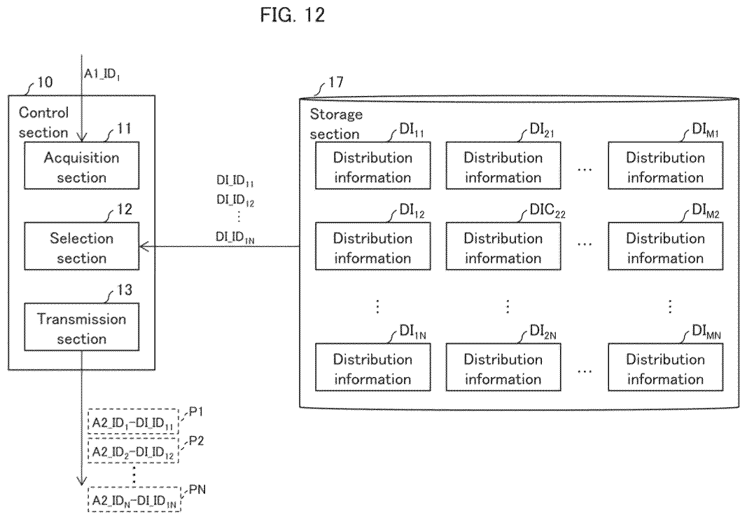

An example of a process which is carried out by the control section 10 of the information processing apparatus 1A will be described with reference to FIG. 12. FIG. 12 is a diagram illustrating an example of a process which is carried out by the control section 10 of the information processing apparatus 1A in accordance with the present example embodiment.

In the following description, a case will be described in which an area 1 is a first area and areas 1 through N are second areas.

An identifier indicating that an area X is a first area is referred to as an identifier A1_ID_{X}, and an identifier indicating that an area X is a second area is referred to as an identifier A2_ID_{X}.

Distribution information associated with a first area and a second area, where the first area is an area X and the second area is an area Y, is referred to as distribution information DI_{XY}, and an identifier of the distribution information is referred to as an identifier DI_ID_{XY}.

First, the acquisition section 11 of the information processing apparatus 1A acquires an identifier A1_ID₁ indicating that the area 1 is the first area. The acquisition section 11 supplies the acquired identifier A1_ID₁ to the 12.

Examples of a configuration in which the acquisition section 11 acquires an identifier of a first area include a configuration in which the acquisition section 11 presents, via the input-output section 16, an image prompting a user to input an identifier of a first area and acquires the identifier of the first area that has been input with respect to the image.

Subsequently, upon acquisition of the identifier A1_ID₁ from the acquisition section 11, the selection section 12 refers to the storage section 17 and selects distribution information which is associated with the area 1 indicated by the identifier A1_ID₁ and which is associated with each of a plurality of second areas. Examples of distribution information stored in the storage section 17 include pieces of distribution information DI₁₁ through DI_{MN}, as illustrated in FIG. 12. The storage section 17 also stores identifiers DI_ID₁₁ through DI_ID_{MN} (not illustrated) indicating the pieces of distribution information DI₁₁ through DI_{MN}, respectively.

In the example illustrated in FIG. 12, the selection section 12 selects pieces of distribution information DI₁₁ through DI_{IN} which are associated with the area 1 indicated by the identifier A1_ID₁ of the first area and which are associated with the respective plurality of second areas. Then, as illustrated in FIG. 12, the selection section 12 acquires, from the storage section 17, the identifiers DI_ID₁₁ through DI_ID_{IN} indicating the selected pieces of distribution information DI₁₁ through DI_{IN}, respectively. The selection section 12 supplies the acquired identifiers DI_ID₁₁ through DI_ID_{IN} to the transmission section 13.

Next, the transmission section 13 generates pairs P1 through PN each of which is data including a set of an identifier of a second area and an identifier of distribution information which has been selected by the selection section 12 for the second area.

For example, the transmission section 13 refers to the identifiers DI_ID₁₁ through DI_ID_{IN} supplied from the selection section 12 and generates pairs P1 through PN including the respective identifiers and identifiers indicating second areas corresponding to the respective identifiers. For example, for the identifier DI_ID₁₁, a corresponding second area is the area 1. Therefore, the transmission section 13 generates a pair P1 including the identifier DI_ID₁₁ and the identifier A2_ID₁ indicating that the area 1 is the second area, as illustrated in FIG. 12. Similarly, the transmission section 13 generates a pair PN including the identifier DI_ID_{IN} and an identifier A2_ID_{N} indicating that the area N is the second area.

Then, the transmission section 13 transmits the generated pairs P1 through PN to the communication control apparatus 2A via the communication section 15.

Here, the transmission section 13 can include, in the pairs P1 through PN, information instructing distribution of distribution information using ETWS. With this configuration, the transmission section 13 can reduce a load of processing in which the communication control apparatus 2A, the transmission apparatus 3A, and the terminal apparatus 4A transmit and receive data.

### Example of Process Which is Carried Out by Control Section 20 of Communication Control Apparatus 2A

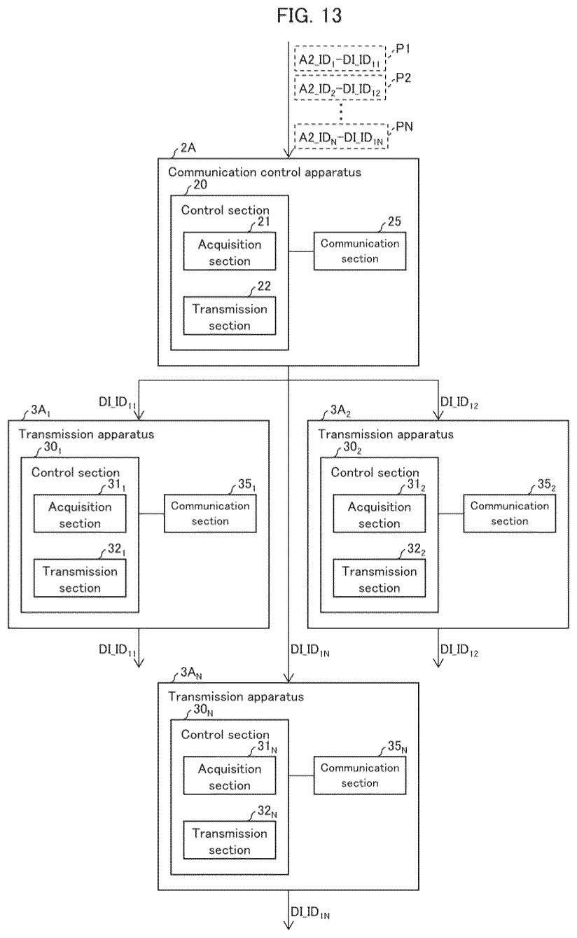

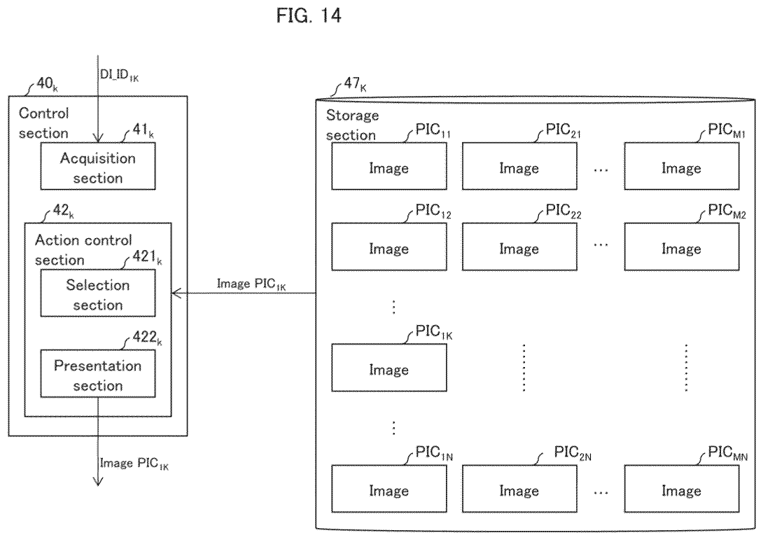

An example of a process which is carried out by the control section 20 of the communication control apparatus 2A will be described with reference to FIG. 13. FIG. 13 is a diagram illustrating an example of a process which is carried out by the control section 20 of the communication control apparatus 2A and the control section 30 of the transmission apparatus 3A in accordance with the present example embodiment.

In the following description also, a case will be described in which an area 1 is a first area and areas 1 through N are second areas.

First, the acquisition section 21 of the communication control apparatus 2 acquires, via the communication section 25, pairs P1 through PN which are transmitted from the information processing apparatus 1A, as illustrated in FIG. 13. The acquisition section 21 supplies the acquired pairs P1 through PN to the transmission section 22.

Subsequently, the transmission section 22 transmits, to transmission apparatuses 3A₁ through 3A_{N} which correspond to areas respectively indicated by second area identifiers A2_ID₁ through A2_ID_{N} included in the pairs P1 through PN supplied from the acquisition section 21, identifiers DI_ID₁₁ through DI_ID_{IN} of pieces of distribution information which are included in the pairs P1 through PN and are of the pieces of distribution information for the respective second areas.

For example, the transmission section 22 transmits the identifier DI_ID₁₁ of the distribution information included in the pair P1 to the transmission apparatus 3A₁ corresponding to the area 1 indicated by the identifier A2_ID₁ of the second area included in the pair P1. Similarly, the transmission section 22 transmits the identifier DI_ID_{IN} of the distribution information included in the pair N to the transmission apparatus 3A_{N} corresponding to the area N indicated by the identifier A2_ID_{N} of the second area included in the pair N.

Here, the transmission section 22 may transmit, to the transmission apparatus 3A, an identifier of distribution information for a second area by including the identifier in a notification that is distributed using ETWS. With this configuration, the transmission section 22 can reduce a load of processing in which the communication control apparatus 2A, the transmission apparatus 3A, and the terminal apparatus 4A transmit and receive data.

### Example of Process Which is Carried Out by Control Section 30 of Transmission Apparatus 3A

An example of a process which is carried out by the control section 30 of the transmission apparatus 3A will be described with reference to FIG. 13.

In the following description also, a case will be described in which an area 1 is a first area and areas 1 through N are second areas.

In a transmission apparatus 3A_{X} covering an area X, a control section 30 is referred to as a control section 30_{X}, an acquisition section 31 is referred to as an acquisition section 31_{X}, and a transmission section 32 is referred to as a transmission section 32_{X}.

First, acquisition sections 31₁ through 31_{N} of the respective transmission apparatuses 3A₁ through 3A_{N} respectively acquire identifiers DI_ID₁₁ through DI_ID_{IN} of pieces of distribution information which are for second areas covered by the respective transmission apparatuses 3A₁through 3A_{N} and which have been transmitted from the communication control apparatus 2A. The acquisition sections 31₁ through 31_{N} supply, to the transmission sections 32₁ through 32_{N}, the acquired identifiers DI_ID₁₁ through DI_ID_{IN}, respectively.

The transmission sections 32₁ through 32_{N} respectively transmit the identifiers DI_ID₁₁ through DI_ID_{IN} of the pieces of distribution information one or more terminal apparatuses 4A that are present in the second areas.

For example, in the diagram illustrated in FIG. 10, the acquisition section 311 acquires the identifier DI_ID₁₁ of distribution information for the area 1 which is a second area covered by the transmission apparatus 3A₁. The transmission section 32₁ transmits the identifier DI_ID₁₁ of the distribution information to a terminal apparatus 4A₁₁ and a terminal apparatus 4A₁₂ that are present in the area 1. Similarly, the acquisition section 31_{N} acquires an identifier DI_ID_{IN} of distribution information for the area N that is a second area covered by the transmission apparatus 3A_{N}. Then, the transmission section 32_{N} transmits the identifier DI_ID_{IN} of the distribution information to a terminal apparatus 4A_{N1} and a terminal apparatus 4A_{N2} that are present in the area N.

Here, the acquisition section 31 may acquire an identifier of distribution information from a notification which is distributed using ETWS. The transmission section 32 may transmit, to one or more terminal apparatuses 4A, an identifier of distribution information by including the identifier in a notification which is distributed using ETWS. With this configuration, the transmission apparatus 3A can reduce a load of processing of transmitting and receiving data. The transmission apparatus 3A can reduce a load of processing in which the terminal apparatus 4A receives data.

### Example 1 of Process Which is Carried Out by Control Section 40 of Terminal Apparatus 4A

An example of a process which is carried out by the control section 40 of the terminal apparatus 4A will be described with reference to FIG. 14. FIG. 14 is a diagram illustrating an example of a process which is carried out by the control section 40 of the terminal apparatus 4A in accordance with the present example embodiment.

In the following description also, a case will be described in which an area 1 is a first area and areas 1 through N are second areas. The following description will discuss a case in which presentation information is an image.

In a terminal apparatus 4A_{X}, a control section 40 is referred to as a control section 40_{X}, an acquisition section 41 is referred to as an acquisition section 41_{X}, an action control section 42 is referred to as an action control section 42_{X}, a selection section 421 is referred to as a selection section 421_{X}, and a presentation section 422 is referred to as a presentation section 422_{X}. An image which is presentation information corresponding to an identifier DI_ID_{XY} of distribution information is referred to as an image PIC_{XY}. The following description will discuss an example of a process which is carried out by a control section 40_{K} of a terminal apparatus 4A_{K}.

First, the acquisition section 41_{K} of the terminal apparatus 4A_{K} acquires an identifier DI_ID_{1K} of distribution information that is associated with an area 1 which is a first area and an area K which is a second area in which the terminal apparatus 4A_{K} is present and that is for the area K which is a second area. The acquisition section 41_{K} supplies the acquired identifier DI_ID_{1K} to the action control section 42_{K}.

Next, the action control section 42_{K} carries out predetermined action control in response to acquisition of the identifier DI_ID_{1K}. For example, a configuration in which the action control section 42_{K} displays an image will be described.

Upon acquisition of the identifier DI_ID_{1K}, the selection section 421_{K} of the action control section 42_{K} selects an image PIC_{1K} corresponding to the identifier DI_ID_{1K}from among images PIC₁₁ through PIC_{MN} stored in the storage section 47_{K}. Upon acquisition of the selected image PIC_{1K}, the selection section 421_{K} supplies the image PIC_{1K} to the section 422_{K}.

The presentation section 422_{K} presents, to a user via the input-output section 46, the image PIC_{1K} supplied from the selection section 421_{K}.

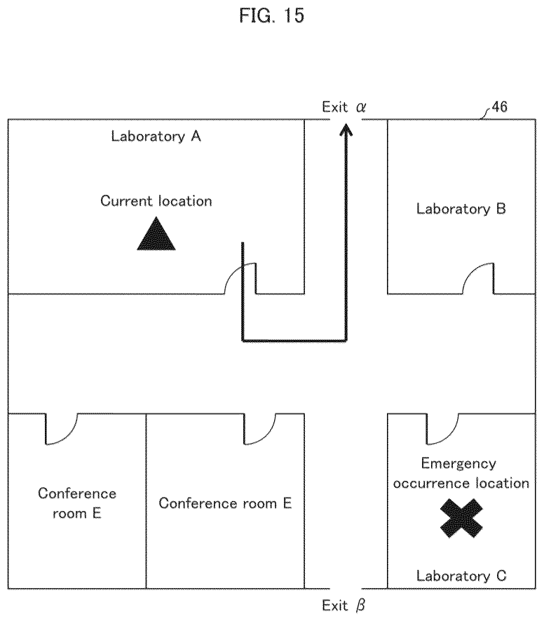

An example of an image which is presented to a user by the presentation section 422 via the input-output section 46 will be described with reference to FIG. 15. FIG. 15 is a diagram illustrating an example of an image which is presented to a user by the presentation section 422 in accordance with the present example embodiment.

As illustrated in FIG. 15, the presentation section 422 presents, for example, an image indicating a route to the user via the input-output section 46. By presenting the image, the presentation section 422 can present, to the user, which route the user should follow.

The image illustrated in FIG. 15 further indicates a current location (in other words, a second area) and an emergency occurrence location (in other words, a first area). By presenting the image, the presentation section 422 can inform the user of a more appropriate evacuation route. identifier of distribution information from a notification which is distributed using ETWS. With this configuration, the terminal apparatus 4A can reduce a load of processing of receiving data.

### Example 2 of Process Which is Carried Out by Control Section 40 of Terminal Apparatus 4A

Another example of a process which is carried out by the control section 40 of the terminal apparatus 4A will be described with reference to FIG. 16. FIG. 16 is a diagram illustrating another example of a process which is carried out by the control section 40 of the terminal apparatus 4A in accordance with the present example embodiment.

The following description will discuss a case of acquiring presentation procedure information indicating a procedure in which the action control section 42 stops action of an apparatus. The following description will discuss also an example of a process which is carried out by a control section 40_{K} of a terminal apparatus 4A_{K}.

First, the acquisition section 41_{K} of the terminal apparatus 4A_{K} acquires an identifier DI_ID_{1K}of distribution information that is associated with an area 1 which is a first area and an area K which is a second area in which the terminal apparatus 4A_{K} is present and that is for the area K which is a second area. The acquisition section 41_{K} supplies the acquired identifier DI_ID_{1K} to the action control section 42_{K}.

Next, the action control section 42_{K} carries out predetermined action control in response to acquisition of the identifier DI_ID_{1K}. For example, the action control section 42_{K} stops action of the terminal apparatus 4A_{K} or one or more apparatuses which are connected to the terminal apparatus 4A_{K}.

Specifically, upon acquisition of the identifier DI_ID_{1K}, the action control section 42_{K} acquires, from the storage section 47_{K}, stop procedure information SPI indicating a procedure of stopping action of the terminal apparatus 4A_{K} or one or more apparatuses which are connected to the terminal apparatus 4A_{K}. The action control section 42_{K} refers to the acquired stop procedure information SPI and stops action of the terminal apparatus 4A_{K} or one or more apparatuses which are connected to the terminal apparatus 4A_{K}.

For example, as illustrated in FIG. 16, the action control section 42_{K} may present, to the user via the input-output section 46, an image PSP including a procedure for stopping action of the terminal apparatus 4A_{K} or one or more apparatuses which are connected to the terminal apparatus 4A_{K}, with reference to the acquired stop procedure information SPI. With this configuration, the action control section 42_{K} can present a procedure of stopping the apparatus to the user.

### Example 3 of Process Which is Carried Out by Control Section 40 of Terminal Apparatus 4A

Still another example of a process which is carried out by the control section 40 of the terminal apparatus 4A will be described.

In a case where pieces of distribution information stored in the storage section 47 include evacuation route information associated with a first area and a second area, the action control section 42 may stop action of an apparatus which is disposed along an evacuation route indicated by the evacuation route information among one or more apparatuses which are connected to the terminal apparatus 4A. This configuration will be described as follows.

For example, in a case where pieces of distribution information stored in the storage section 47 include evacuation route information indicating an evacuation route illustrated in FIG. 15, the action control section 42 stops action of an apparatus which is disposed along the evacuation route illustrated in FIG. 15. With this configuration, the action control section 42 can stop, without operation by the user, action of an apparatus which is disposed along a route on which the user is to evacuate.

### Example Advantage of Information Distribution System 100A

As described above, in the information processing system 100A in accordance with the present example embodiment, the information processing apparatus 1A acquires an identifier of a first area, selects, as distribution information for each of a plurality of second areas, distribution information which is associated with the first area indicated by the acquired identifier and which is associated with the second area, and transmits, for each of the plurality of second areas, data including an identifier of the second area and an identifier of distribution information which has been selected for the second area.

In the information distribution system 100A in accordance with the present example embodiment, the communication control apparatus 2A acquires data including a plurality of sets each of which is constituted by (i) an identifier of distribution information that is associated with a first area and a second area and that is for the second area and (ii) a second area identifier that indicates each of a plurality of second areas, and transmits, to a transmission apparatus 3A which corresponds to each area indicated by the second area identifier, the identifier of the distribution information for the second area.

In the information distribution system 100A in accordance with the present example embodiment, the transmission apparatus 3A acquires an identifier of distribution information which is associated with a first area and a second area and which is for the second area covered by the transmission apparatus 3A, and transmits the identifier of the distribution information to one or more terminal apparatuses 4A which are present in the second area.

In the information distribution system 100A in accordance with the present example embodiment, the terminal apparatus 4A acquires an identifier of distribution information that is associated with a first area and a second area in which the terminal apparatus 4A is present and that is for the second area, and carries out predetermined action control in response to acquisition of the identifier of the distribution information.

As such, according to the information distribution system 100A in accordance with the present example embodiment, the information processing apparatus 1A, the communication control apparatus 2A, the transmission apparatus 3A, and the terminal apparatus 4A transmit and receive distribution information associated with two areas (i.e., the first area and the second area). Therefore, it is possible to bring about an example advantage of transmitting and receiving appropriate distribution information as compared with information which is associated with only one of areas.

### Software Implementation Example

The functions of part of or all of the information processing apparatuses 1 and 1A, communication control apparatuses 2 and 2A, transmission apparatuses 3 and 3A, and terminal apparatuses 4 and 4A can be realized by hardware such as an integrated circuit (IC chip) or can be alternatively realized by software.

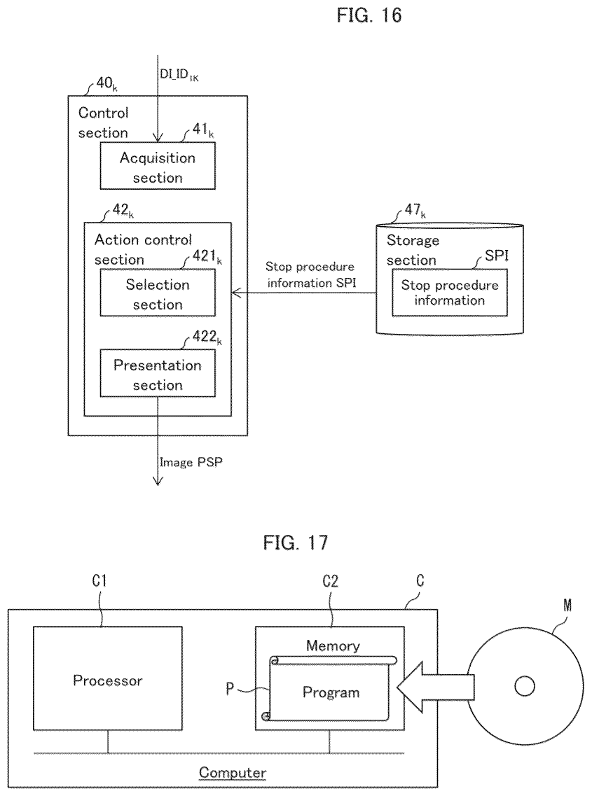

In the latter case, the information processing apparatuses 1 and 1A, communication control apparatuses 2 and 2A, transmission apparatuses 3 and 3A, and terminal apparatuses 4 and 4A are implemented by, for example, a computer that executes instructions of a program that is software implementing the foregoing functions. FIG. 17 illustrates an example of such a computer (hereinafter, referred to as “computer C”). The computer C includes at least one processor Cl and at least one memory C2. The memory C2 stores a program P for causing the computer C to operate as the information processing apparatuses 1 and 1A, communication control apparatuses 2 and 2A, transmission apparatuses 3 and 3A, and terminal apparatuses 4 and 4A. The processor C1 of the computer C retrieves the program P from the memory C2 and executes the program P, so that the functions of the information processing apparatuses 1 and 1A, communication control apparatuses 2 and 2A, transmission apparatuses 3 and 3A, and terminal apparatuses 4 and 4A are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### Supplementary Note 1

An information processing apparatus, including: an acquisition means for acquiring an identifier of a first area; a selection means for selecting, as distribution information for each of a plurality of second areas, distribution information which is associated with the first area indicated by the identifier acquired by the acquisition means and which is associated with the second area; and a transmission means for transmitting, for each of the plurality of second areas, data including an identifier of the second area and an identifier of distribution information which has been selected

### Supplementary Note 2

The information processing apparatus according to supplementary note 1, in which: the distribution information includes route information associated with the first area and the second area.

### Supplementary Note 3

The information processing apparatus according to supplementary note 2, in which: the first area is an area related to occurrence of an emergency; the second area is an area to be notified of the occurrence of the emergency; and the distribution information includes evacuation route information associated with the first area and the second area.

### Supplementary Note 4

The information processing apparatus according to any one of supplementary notes 1 through 3, in which: the plurality of second areas correspond to a plurality of cells, respectively, which are provided by a local 5G network.

### Supplementary Note 5

A communication control apparatus, including: an acquisition means for acquiring data including a plurality of sets each of which is constituted by (i) an identifier of distribution information that is associated with a first area and a second area and that is for the second area and (ii) a second area identifier that indicates each of a plurality of second areas; and a transmission means for transmitting, to a transmission apparatus which corresponds to each area indicated by the second area identifier, the identifier of the distribution information for the second area.

### Supplementary Note 6

The communication control apparatus according to supplementary note 5, in which: the distribution information includes route information associated with the first area and the second area.

### Supplementary Note 7

The communication control apparatus according to supplementary note 6, in which: the first area is an area related to occurrence of an emergency; the second area is an area to be notified of the occurrence of the emergency; and the distribution information includes evacuation route information associated with the first area and the second area.

The communication control apparatus according to any one of supplementary notes 5 through 7, in which: the transmission means transmits, to the transmission apparatus, the identifier of the distribution information for the second area by including the identifier in a notification that is distributed using ETWS.

### Supplementary Note 9

The communication control apparatus according to any one of supplementary notes 5 through 8, in which: the second area corresponds to a cell that is provided by a local 5G network.

### Supplementary Note 10

A transmission apparatus, including: an acquisition means for acquiring an identifier of distribution information which is associated with a first area and a second area and which is for the second area covered by the transmission apparatus; and a transmission means for transmitting the identifier of the distribution information to one or more terminal apparatuses which are present in the second area.

### Supplementary Note 11

The transmission apparatus according to supplementary note 10, in which: the distribution 79 information includes route information associated with the first area and the second area.

### Supplementary Note 12

The transmission apparatus according to supplementary note 11, in which: the first area is an area related to occurrence of an emergency; the second area is an area to be notified of the occurrence of the emergency; and the distribution information includes evacuation route information associated with the first area and the second area.

### Supplementary Note 13

The transmission apparatus according to any one of supplementary notes 10 through 12, in which: the acquisition means acquires the identifier of the distribution information from a notification which is distributed using ETWS; and the transmission means transmits, to the one or more terminal apparatuses, the identifier of the distribution information by including the identifier in a notification distributed using ETWS.

### Supplementary Note 14

The transmission apparatus according to any one of supplementary notes 10 through 13, in which: the second area corresponds to a cell that is provided by a local 5G network.

### Supplementary Note 15

A terminal apparatus, including: an acquisition means for acquiring an identifier of distribution information that is associated with a first area and a second area in which the terminal apparatus is present and that is for the second area; and an action control means for carrying out predetermined action control in response to acquisition of the identifier of the distribution information.

### Supplementary Note 16

The terminal apparatus according to supplementary note 15, in which: the distribution information includes route information associated with the first area and the second area.

### Supplementary Note 17

The terminal apparatus according to supplementary note 16, in which: the first area is an area related to occurrence of an emergency; the second area is an area to be notified of the occurrence of the emergency; and the distribution information includes evacuation £ route information associated with the first area and the second area.

### Supplementary Note 18

The terminal apparatus according to any one of supplementary notes 15 through 17, in which: the acquisition means acquires the identifier of the distribution information from a notification which is distributed using ETWS.

### Supplementary Note 19

The terminal apparatus according to any one of supplementary notes 15 through 18, in which: the second area corresponds to a cell that is provided by a local 5G network.

### Supplementary Note 20

The terminal apparatus according to any one of supplementary notes 15 through 19, in which: the action control means includes a selection means for selecting presentation information which is identified by the identifier of the distribution information; and the action control means includes a presentation means for presenting the presentation information which has been selected by the selection means.

### Supplementary note 21

The terminal apparatus according to any one of supplementary notes 15 through 20, in which: the second area is an area to be notified of occurrence of an emergency; and the action control means stops action of the terminal apparatus or one or more apparatuses which are connected to the terminal apparatus.

### Supplementary Note 22

The terminal apparatus according to any one of supplementary notes 15 through 21, in which: the distribution information includes evacuation route information associated with the first area and the second area; and the action control means stops action of an apparatus which is disposed along an evacuation route indicated by the evacuation route information among one or more apparatuses which are connected to the terminal apparatus.

### Supplementary Note 23

An information distribution system including an information processing apparatus, a communication control apparatus, a transmission apparatus, and a terminal apparatus, the information processing apparatus including a first acquisition means for acquiring an identifier of a first area, a first selection means for selecting, as distribution information for each of a plurality of second areas, distribution information which is associated with the first area indicated by the identifier acquired by the first acquisition means and which is associated with the second area, and a first transmission means for transmitting, for each of the plurality of second areas, data to the communication control apparatus, the data including an identifier of the second area and an identifier of distribution information which has been selected for the second area, the communication control apparatus including a second acquisition means for acquiring data which has been transmitted from the information processing apparatus, the data including the identifier of the second area and the identifier of the distribution information which has been selected for the second area, and a second transmission means for transmitting, to a transmission apparatus which corresponds to each area indicated by the identifier of the second area, the identifier of the distribution information for the second area, the transmission apparatus including a third acquisition means for acquiring the identifier of the distribution information for the second area which is covered by the transmission apparatus, the identifier of the distribution information having been transmitted by the communication control apparatus, and a third transmission means for transmitting the identifier of the distribution information to one or more terminal apparatuses which are present in the second area, and the terminal apparatus including a fourth acquisition means for acquiring the identifier of the distribution information for the second area in which the terminal apparatus is present, the identifier of the distribution information having been transmitted by the transmission apparatus, and an action control means for carrying out predetermined action control in response to acquisition of the identifier of the distribution information.

### Supplementary Note 24

An information processing method, including: acquiring, by an information processing apparatus, an identifier of a first area; selecting, as distribution information for each of a plurality of second areas, by the information processing apparatus, distribution information which is associated with the first area indicated by the identifier acquired in the acquiring and which is associated with the second area; and transmitting, for each of the plurality of second areas, by the information processing apparatus, data including an identifier of the second area and an identifier of distribution information which has been selected for the second area.

### Supplementary Note 25

A communication control method, including: acquiring, by a communication control apparatus, data including a plurality of sets each of which is constituted by (i) an identifier of distribution information that is associated with a first area and a second area and that is for the second area and (ii) a second area identifier that indicates each of a plurality of second areas; and transmitting, by the communication control apparatus, the identifier of the distribution information for the second area to a transmission apparatus which corresponds to each area indicated by the second area identifier.

### Supplementary Note 26

A transmission method, including: acquiring, by a transmission apparatus, an identifier of distribution information which is associated with a first area and a second area and which is for the second area covered by the transmission apparatus; and transmitting, by the transmission apparatus, the identifier of the distribution information to one or more terminal apparatuses which are present in the second area.

### Supplementary Note 27

An information processing method, including: acquiring, by a terminal apparatus, an identifier of distribution information that is associated with a first area and a second area in which the terminal apparatus is present and that is for the second area; and carrying out, by the terminal apparatus, predetermined action control in response to acquisition of the identifier of the distribution information.

### Supplementary Note 28

A program for causing a computer to function as an information processing apparatus, the program causing the computer to function as: an acquisition means for acquiring an identifier of a first area; a selection means for selecting, as distribution information for each of a plurality of second areas, distribution information which is associated with the first area indicated by the identifier acquired by the acquisition means and which is associated with the second area; and a transmission means for transmitting, for each of the plurality of second areas, data including an identifier of the second area and an identifier of distribution information which has been selected for the second area.

### Supplementary Note 29

A program for causing a computer to function as a communication control apparatus, the program causing the computer to function as: an acquisition means for acquiring data including a plurality of sets each of which is constituted by (i) an identifier of distribution information that is associated with a first area and a second area and that is for the second area and (ii) a second area identifier that indicates each of a plurality of second areas; and a transmission means for transmitting, to a transmission apparatus which corresponds to each area indicated by the second area identifier, the identifier of the distribution information for the second area.

### Supplementary Note 30

A program for causing a computer to function as a transmission apparatus, the program causing the computer to function as: an acquisition means for acquiring an identifier of distribution information which is associated with a first area and a second area and which is for the second area covered by the transmission apparatus; and a transmission means for transmitting the identifier of the distribution information to one or more terminal apparatuses which are present in the second area.

### Supplementary Note 31

A program for causing a computer to function as a terminal apparatus, the program causing the computer to function as: an acquisition means for acquiring an identifier of distribution information that is associated with a first area and a second area in which the terminal apparatus is present and that is for the second area; and an action control means for carrying out predetermined action control in response to acquisition of the identifier of the distribution information.

### Additional Remark 3

Some or all of the foregoing example embodiments can also be described as below.

An information processing apparatus, including at least one processor, the at least one processor carrying out: an acquisition process of acquiring an identifier of a first area; a selection process of selecting, as distribution information for each of a plurality of second areas, distribution information which is associated with the first area indicated by the identifier acquired by the acquisition means and which is associated with the second area; and a transmission process of transmitting, for each of the plurality of second areas, data including an identifier of the second area and an identifier of distribution information which has been selected for the second area.

Note that the information processing apparatus can further include a memory. The memory can store a program for causing the at least one processor to execute the acquisition process, the selection process, and the transmission process. The program can be stored in a computer-readable non-transitory tangible storage medium.

A communication control apparatus, including at least one processor, the at least one processor carrying out: an acquisition process of acquiring data including a plurality of sets each of which is constituted by (i) an identifier of distribution information that is associated with a first area and a second area and that is for the second area and (ii) a second area identifier that indicates each of a plurality of second areas; and a transmission process of transmitting, to a transmission apparatus which corresponds to each area indicated by the second area identifier, the identifier of the distribution information for the second area.

Note that the communication control apparatus can further include a memory. The memory can store a program for causing the at least one processor to execute the acquisition process and the transmission process. The program can be stored in a computer-readable non-transitory tangible storage medium.

A transmission apparatus, including at least one processor, the at least one processor carrying out: an acquisition process of acquiring an identifier of distribution information which is associated with a first area and a second area and which is for the second area covered by the transmission apparatus; and a transmission process of transmitting the identifier of the distribution information to one or more terminal apparatuses which are present in the second area.

Note that the transmission apparatus can further include a memory. The memory can store a program for causing the at least one processor to execute the acquisition process and the transmission process. The program can be stored in a computer-readable non-transitory tangible storage medium.

A terminal apparatus, including at least one processor, the at least one processor carrying out: an acquisition process of acquiring an identifier of distribution information that is associated with a first area and a second area in which the terminal apparatus is present and that is for the second area; and an action control process of carrying out predetermined action control in response to acquisition of the identifier of the distribution information.

Note that the terminal apparatus can further include a memory. The memory can store a program for causing the at least one processor to execute the acquisition process and the transmission process. The program can be stored in a computer-readable non-transitory tangible storage medium.

### REFERENCE SIGNS LIST

1, 1A: Information processing apparatus
2, 2A: Communication control apparatus
3, 3A: Transmission apparatus
4, 4A: Terminal apparatus
11, 21, 31, 41: Acquisition section
12, 421: Selection section
13, 22, 32: Transmission section
42: Action control section
422: Presentation section
100, 100A: Information distribution system

What is claimed is:

1. An information processing apparatus, comprising at least one processor, the at least one processor carrying out:
an acquisition process of acquiring an identifier of a first area;
a selection process of selecting, as distribution information for each of a plurality of second areas, distribution information which is associated with the first area indicated by the identifier acquired in the acquisition process and which is associated with the second area; and
a transmission process of transmitting, for each of the plurality of second areas, data including an identifier of the second area and an identifier of distribution information which has been selected for the second area.

2. The information processing apparatus according to claim 1, wherein:
the distribution information includes route information associated with the first area and the second area.

3. The information processing apparatus according to claim 2, wherein:
the first area is an area related to occurrence of an emergency;
the second area is an area to be notified of the occurrence of the emergency; and
the distribution information includes evacuation route information associated with the first area and the second area.

4. The information processing apparatus according to claim 1, wherein:
the plurality of second areas correspond to a plurality of cells, respectively, which are provided by a local 5G network.

5. A communication control apparatus, comprising at least one processor, the at least one processor carrying out:
an acquisition process of acquiring data including a plurality of sets each of which is constituted by (i) an identifier of distribution information that is associated with a first area and a second area and that is for the second area and (ii) a second area identifier that indicates each of a plurality of second areas; and
a transmission process of transmitting, to a transmission apparatus which corresponds to each area indicated by the second area identifier, the identifier of the distribution information for the second area.

6. The communication control apparatus according to claim 5, wherein:
the distribution information includes route information associated with the first area and the second area.

7. The communication control apparatus according to claim 6, wherein:
the first area is an area related to occurrence of an emergency;
the second area is an area to be notified of the occurrence of the emergency; and
the distribution information includes evacuation route information associated with the first area and the second area.

8. The communication control apparatus according to claim 5, wherein:
in the transmission process, the at least one processor transmits, to the transmission apparatus, the identifier of the distribution information for the second area by including the identifier in a notification that is distributed using ETWS.

9. The communication control apparatus according to claim 5, wherein:
the second area corresponds to a cell that is provided by a local 5G network.

10.-cm 23. (canceled)

24. An information processing method, comprising:
acquiring, by an information processing apparatus, an identifier of a first area;
selecting, as distribution information for each of a plurality of second areas, by the information processing apparatus, distribution information which is associated with the first area indicated by the identifier acquired in the acquiring and which is associated with the second area; and
transmitting, for each of the plurality of second areas, by the information processing apparatus, data including an identifier of the second area and an identifier of distribution information which has been selected for the second area.

25.-cm 27. (canceled)

28. A computer-readable non-transitory storage medium storing a program for causing a computer to function as an information processing apparatus recited in claim 1, the program causing the computer to carry out the acquisition process, the selection process, and the transmission process.

29. A computer-readable non-transitory storage medium storing a program for causing a computer to function as a communication control apparatus recited in claim 5, the program causing the computer to carry out the acquisition process and the transmission process.

30.-cm 31. (canceled)
